(19) United States
(12) Patent Application Publication
(10) Pub. No.: US 2004/0163907 A1
(43) Pub. Date: Aug. 26, 2004

(54) Cushion assembly for motorcycles

(76) Inventor: Chi-Tai Su, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/370,478

(22) Filed: Feb. 24, 2003

(51) Int. Cl. F16F 9/00; F16F 9/34

(52) U.S. Cl. 188/317; 188/318; 188/322.13

(57) ABSTRACT

A cushion assembly for motorcycles includes an outer tube having a recess defined through a first end thereof and a hydraulic cylinder is received in the recess. A valve is connected to the cylinder and communicates with a locking hole defined in a second end of the outer tube. A cap is engaged with an opening in the first end of the outer tube and has a through hole so that an inner tube is movably inserted through the through hole in the cap, received in the recess and engaged with the cylinder. The length of the outer tube and the recess are made longer so as to be installed to a modified version of motorcycles.

### FIELD OF THE INVENTION

The present invention relates to a cushion assembly for motorcycles, and more particularly, to a cushion assembly that has longer outer tube so as to be connected to the motorcycle frame which is raised above the ground.

### BACKGROUND OF THE INVENTION

A conventional cushion assembly for motorcycles is shown in FIGS. 1 and 2, and generally includes an outer tube 10 that has a recess 13 defined through an end thereof so that a hydraulic cylinder 12 is received therein. A valve 16 is connected to the cylinder 12 and located close to the locking hole 15 in the outer tube 10. A cap 14 seals the opening in the outer tube 10 and an inner tube 11 is movably inserted in the recess 13 and engaged with the cylinder 12 so that the inner tube 11 is able to sink into the outer tube 10 to absorb the shocks of the loads. The maximum length of the cushion assembly is fixed so that it is not able to be connected to the frame of a modified version of motorcycles and the front wheel hub if the frame is raised to increase the distance between the front wheel and the body of the motorcycle.

The present invention intends to provide a cushion assembly that has a longer outer tube and a deeper recess so that a longer section of the inner tube can be enclosed by the outer tube, and the assembly can be installed to the modified version of heavy motorcycle.

### SUMMARY OF THE INVENTION

In accordance with one aspect of the present invention, there is provided a cushion assembly for motorcycles and comprises an outer tube having a recess defined through a first end thereof and a hydraulic cylinder is received in the recess. A valve is connected to the cylinder and communicates with a locking hole defined in a second end of the outer tube. A cap having a through hole is engaged with an opening in the first end of the outer tube and an inner tube is movably inserted through the through hole. The inner tube is movably received in the recess and engaged with the cylinder.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the conventional cushion assembly for motorcycles;

FIG. 2 is a cross sectional view to show the conventional cushion assembly for motorcycles;

FIG. 3 is a perspective view to show the cushion assembly for motorcycles of the present invention;

FIG. 4 shows the cushion assembly is installed to a motorcycle;

FIG. 5 is a cross sectional view to show the cushion assembly of the present invention, and

FIG. 6 shows a cross sectional view of a comparison between the cushion assembly of the present invention and the conventional cushion assembly.

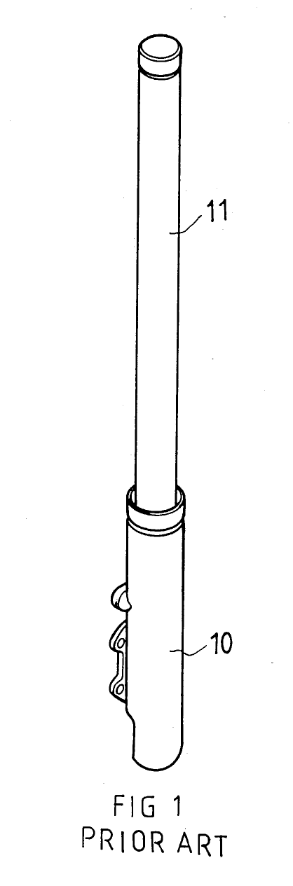

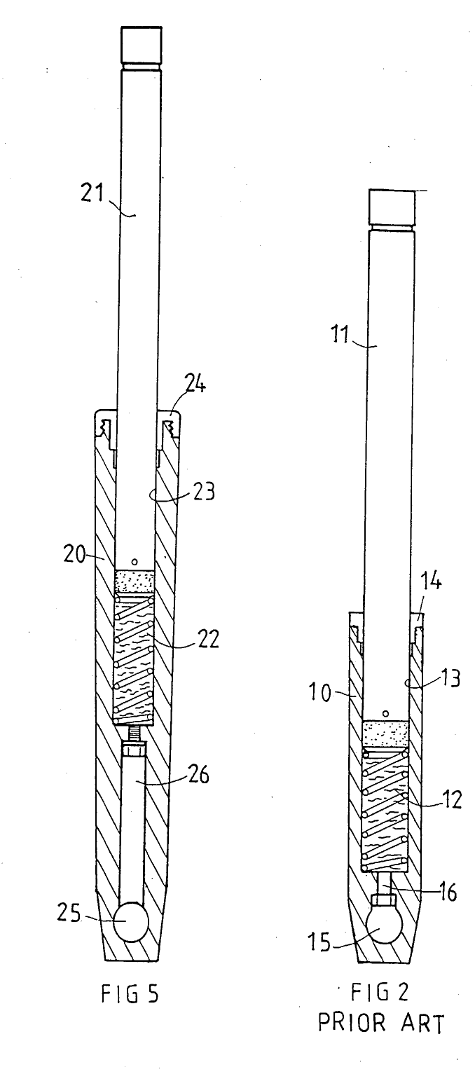

### DETAILED DESCRIPTION OF THE PREFERRED EMBODIMENT

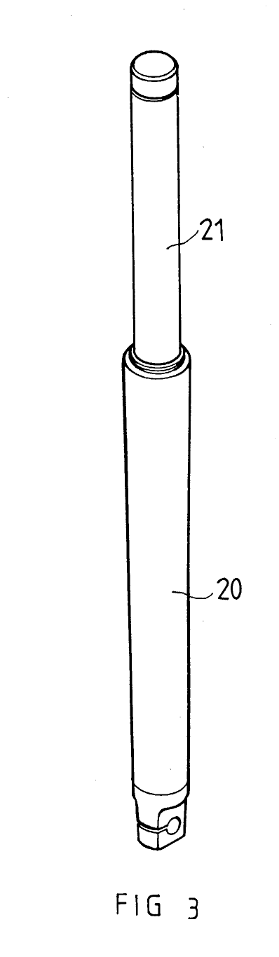

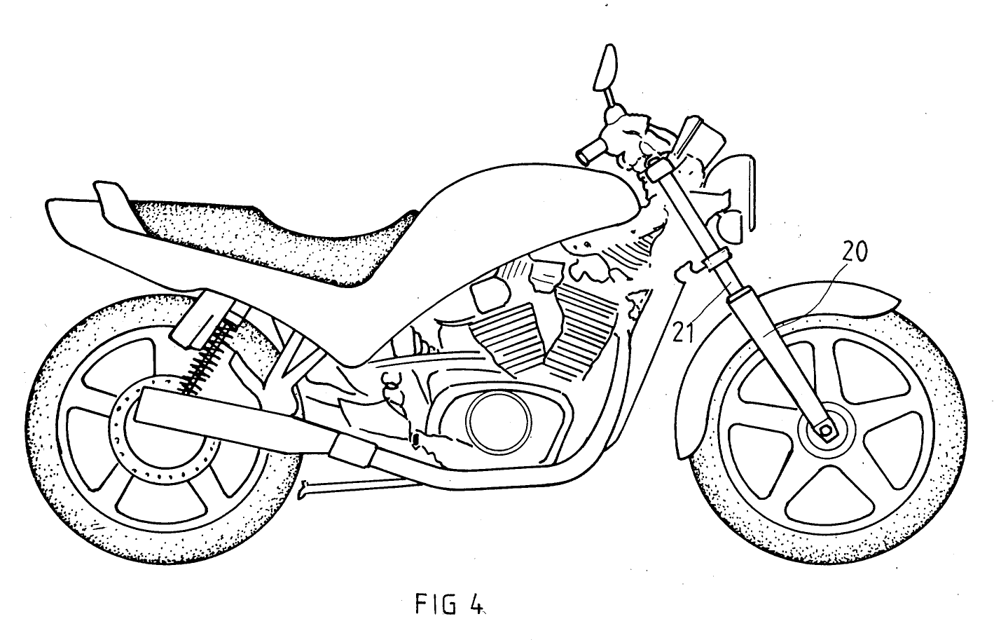

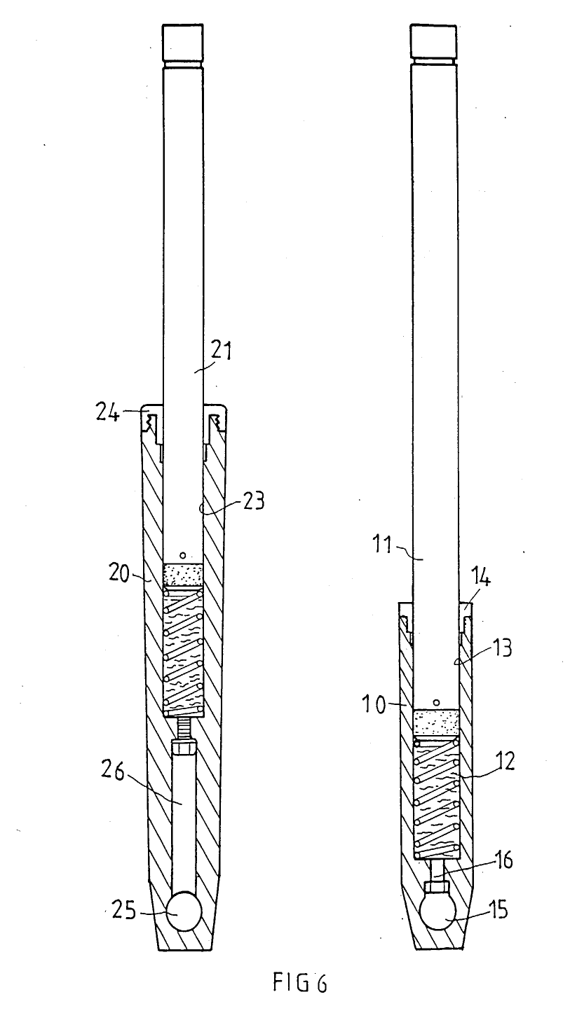

Referring to FIGS. 3 to 5, the cushion assembly for motorcycles of the present invention comprises an outer tube 20 having a recess 23 defined through a first end thereof and a hydraulic cylinder 22 is received in the recess 23. A valve 26 is connected to the cylinder 22 and communicates with a locking hole 25 defined in a second end of the outer tube 20. A cap 24 is engaged with an opening in the first end of the outer tube 20 and has a through hole through which an inner tube 21 movably inserted. The inner tube 21 is movably received in the recess 23 and engaged with the cylinder 22.

The length of the outer tube 20 and the recess 23 are both longer than those of the conventional cushion assembly so that there is a longer section of the inner tube 21 is embraced by the outer tube 20 so that the inner tube 21 is well supported when it moves in the recess 23. The longer total length of the whole cushion assembly allows the cushion assembly to be conveniently installed to a modified version of motorcycle. As shown in FIG. 6, when the total length of the cushion assembly of the present invention and the conventional cushion assembly is then same, a shorter inner tube 21 is used in the cushion assembly, and this is more economy for the users.

While we have shown and described the embodiment in accordance with the present invention, it should be clear to those skilled in the art that further embodiments may be made without departing from the scope of the present invention.

What is claimed is:

1. A cushion assembly for motorcycles, comprising:
an outer tube having a recess defined through a first end thereof and a hydraulic cylinder received in the recess, a valve connected to the cylinder and communicating with a locking hole defined in a second end of the outer tube, a cap engaged with an opening in the first end of the outer tube and having a through hole, and
an inner tube movably inserted through the through hole in the cap, received in the recess and engaged with the cylinder.
